(19) United States
(12) Patent Application Publication
(10) Pub. No.: US 2008/0276515 A1
(43) Pub. Date: Nov. 13, 2008

(54) Firefighting Primary, Secondary, and Final Search Tagging System

(76) Inventor: James Kull, Chicago, IL (US)

Correspondence Address: THE ECLIPSE GROUP LLP, 10605 BALBOA BLVD., SUITE 300, GRANADA HILLS, CA, 91344, US

(21) Appl. No.: 11/817,870

(22) PCT Filed: Mar. 30, 2006
(86) PCT No.: PCT/US06/12096

§ 371 Date: Apr. 14, 2008

Related U.S. Application Data
(60) Provisional application No. 60/666,846, filed on Mar. 31, 2005.

(51) Int. Cl. G09F 3/02; A62C 39/00

(52) U.S. Cl. 40/674

(57) ABSTRACT

A firefighting primary, secondary, and final search tagging system for quickly and clearly indicating the status of fire, rescue and emergency operations in commercial and residential buildings with multiple rooms.

### REFERENCE TO EARLIER-FILED APPLICATION

This application claims the benefit of U.S. Provisional Application Ser. No. 60/666,846 titled “Firefighting Primary, Secondary, and Final Search Tagging System,” filed Mar. 31, 2005, which application is incorporated herein, in its entirety, by this reference.

### BACKGROUND OF THE INVENTION

1. Field of Invention

The invention relates to firefighting tagging systems, and in particular, to a firefighting primary, secondary, and final search tagging system.

2. Related Art

In general, the duties of a fire department in the course of firefighting include searching for life, rescuing victims, and examining for fire. In fulfilling these duties, the fire department may implement standardized policies and procedures relative to searches and rescue operations conducted at the scene of the fire, rescue or other emergency operations. For example, searches may be carried out first to rescue people, then bring the fire under control, and then finally examine and secure the structure where the fire occurred after the fire has been put out.

One such policy may consist of a primary search, a secondary search, and a final search, where the primary search may be a rapid interior search for victims in smoke filled or fire threatened areas of a structure involved in a fire. Where loss of lives is a possibility, a primary search is initiated as soon as possible by the first arriving team of firefighters.

A secondary search is a complete and systematic search of the entire area and surrounding areas while the fire is being brought under control. After the fire is brought under control, the final search takes place, which is a complete and systematic search of the entire building and its surrounding areas. The final search may include examination of the building for areas of structural collapse or instability and implementing remedial measures, such as shoring, where necessary.

As the various types of searches are conducted throughout a building, there is the possibility that some areas may be repeatedly searched, while other areas may remain unsearched. Also there is a need to keep track of what type of search has been conducted at any particular area. Verbal and radio communication are not effective means to communicate exactly which areas (e.g., rooms, floors, etc.) have been searched because of radio transmission problems and also because such communication systems would not be able to simultaneously communicate the volume of information required in the case of a multi-story, multi-unit structure. Thus there is a need for a highly visible, tangible, standardized accountability system that can be easily implemented by the team members as they conduct their searches and that will quickly indicate to others the search status of any particular area at the scene of the firefighting or rescue operation.

### SUMMARY

A firefighting primary, secondary, and final search tagging system for quickly and clearly indicating the status of fire, rescue and emergency operations in commercial and residential buildings with multiple rooms or enclosed areas is described. There is a need at fire and rescue operations for a standardized way to indicate that primary, secondary, and final search procedures have been carried out and/or still need to be carried out. The primary, secondary, and final search tags (“PSF tags”) are a practical solution for this problem. The PSF tags are highly visible, can be recognized by touch when in place, and are disposable when the final search is concluded. Ultimately, the PSF tags save time and money by preventing duplication of effort and provide more orderly and accurate account searches.

As an example of an implementation of the PSF tagging system, a PSF tag may comprise two or more lower portions that are detachable from a top portion. The lower portion tags may be readily removable from the PSF tag with or without a perforation or cut link between the individual tags. The PSF tag may have a self-adhesive backing that may extend over only the top portion of the PSF tag or the entire PSF tag may have a self-adhesive backing. The PSF tag may also have a hole in the top portion for hanging the PSF tag on a doorknob or the PSF tag may be attached to the flat part of a door or wall in the area under search using the self-adhesive backing. Each separate portion of a PSF tag may have lettering and coloring designed to quickly inform the team members of the search status of the area under search. As a fire or rescue team proceeds through a multi-room building, a PSF tag is placed on a door or wall where a primary search is being performed. As a fire or rescue team completes a secondary or primary search of a room, a team member will remove the lower portions of the PSF tags as appropriate.

Other systems, methods and features of the invention will be or will become apparent to one with skill in the art upon examination of the following figures and detailed description. It is intended that all such additional systems, methods, features and advantages be included within this description, and be within the scope of the invention.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1A shows a sketch of an example of a primary, secondary, and final search tag (“PSF tag”) 100 in accordance with the present invention that has detachable Final-Search and Secondary-Search tags.

FIG. 1B shows a sketch of the PSF tag 100 of FIG. 1A with the Secondary-Search tag removed.

FIG. 1C shows a sketch of the PSF tag 100 of FIG. 1B with the Final-Search tag removed.

FIG. 2 shows a sketch of another example of a PSF tag 200 in accordance with the present invention.

FIG. 3 shows a flow diagram of the steps performed in a process using the PSF tag shown in FIGS. 1A and 2.

### DETAILED DESCRIPTION

In the following description of the preferred embodiment, reference is made to the accompanying drawings that form a part hereof, and which shows, by way of illustration, a specific embodiment in which the invention may be practiced. Other embodiments may be utilized and changes may be made without departing from the scope of the present invention.

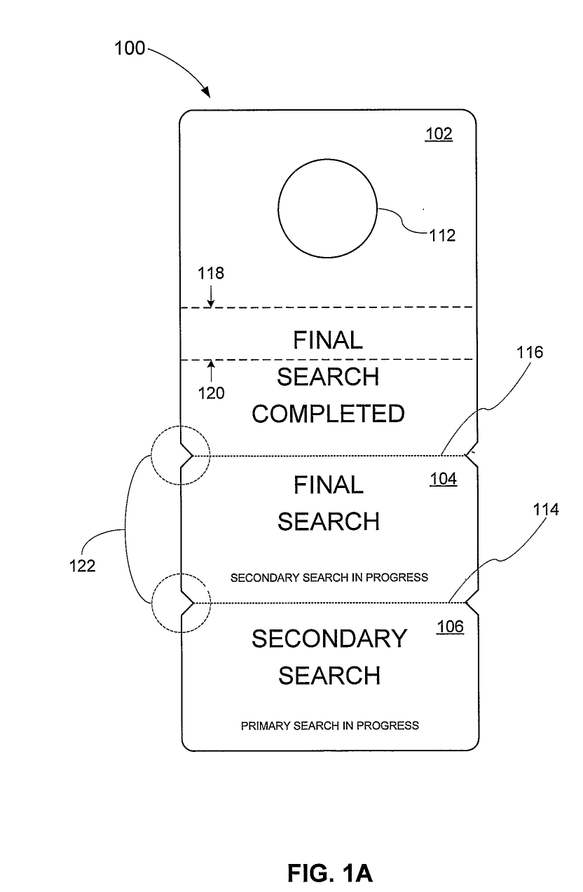

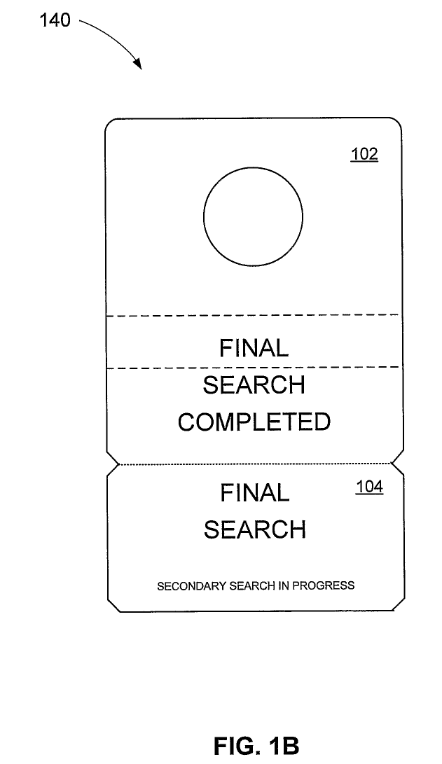

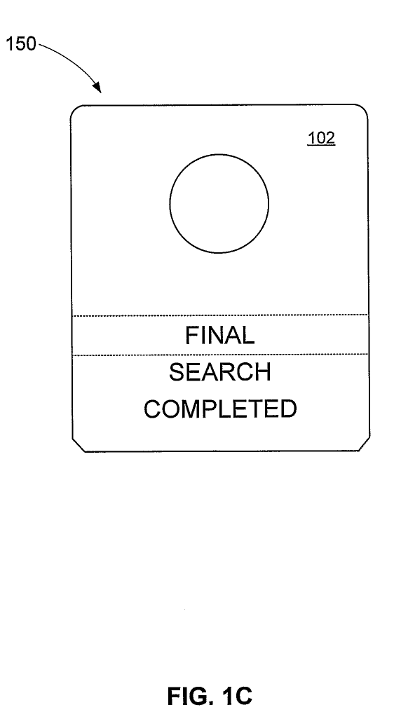

FIG. 1A shows a sketch of an example of a primary, secondary, and final search tag (“PSF tag”) 100 in accordance with the present invention that has detachable Final-Search and Secondary-Search tags. The PSF tag 100 may include three search tags: a Final-Search-Completed tag 102, a detachable Final-Search tag 104, and a detachable Secondary-Search tag 106. The PSF tag 100 may be of any size; as an example, the PSF tag 100 may be 4″ by 8½″ (again, FIG. 1A is not drawn to scale). Also, the PSF tag 100 may be made out of various materials, such as coated paper, plastic, etc., which may also include fire-resistant materials.

The colors of the background and the lettering of the Final-Search-Completed tag 102, the Final-Search tag 104, and the Secondary-Search tag 106 may be any combination of colors that will enhance the visibility of the PSF tag 100. As an example, the lettering of the Final-Search-Completed tag 102 may be day glow orange on a black background, the Final-Search tag 104 may also have day glow orange lettering on a black background, and the Secondary-Search tag 106 may have black lettering on a day glow orange background. Day glow yellow, green, and pink, or any other florescent color, may be substituted for day glow orange, and the colors of the background and lettering may be in any combination conducive to visibility.

As an example of the usage of a set of the PSF tags, a PSF tag may be placed so as to communicate or indicate to a member of a fire or rescue team that the PSF tag identifies a specific defined or enclosed area that is to be searched by the fire or rescue team. For example, a PSF tag 100 may be placed outside of the door when a team member enters a room to perform a search. PSF tags may be placed on doorknobs where possible (using the preformed hole 112), or just stuck to any flat surface that will identify the area under search, e.g., a wall or a door, using a self-adhesive backing affixed to the reverse side, i.e., the side without the lettering, of the PSF tags. The area on the reverse side of the PSF tag 100 where an adhesive may be applied is delineated by dashed lines 118 and 120. The placement of the PSF tags will indicate to others that a primary and/or secondary/final search has been initiated and/or completed in a particular area corresponding to the PSF tag.

In an example of operation, a PSF tag 100 may be placed on any door/wall where a primary search has begun. The presence of the PSF tag 100 will indicate to other members of a fire and rescue team that a primary search of the pertinent area is under way. When a team member (who is conducting the primary search) completes this search, he may rip off the lowest section of the PSF Tag 100 (the Secondary-Search tag 106) and then proceed with a primary search in another area of the premises. To facilitate removal of the Secondary-Search tag 106, the PSF Tag 100 may include a perforated line or cut-line 114 delineating the Secondary-Search tag 106 from the PSF Tag 100.

FIG. 1B shows a sketch of the PSF tag 100 of FIG. 1A with the Secondary-Search tag removed. In FIG. 1B, PSF tag 140 remains in place, with the Secondary-Search tag 106, FIG. 1A, removed, leaving Final-Search tag 104 and Final-Search Completed tag 102 in place. As indicated by Final-Search tag 104, PSF tag 140 indicates to a fire or rescue team that a primary search of the pertinent area has already been performed and a secondary search is in progress.

When the final search of an area is ordered, the Final-Search tag 104 of the PSF tag 100 is then torn off. To facilitate removal of the Final-Search tag 104, the PSF Tag 100 may include a perforated line or cut-line 116, FIG. 1A, delineating the Final-Search tag 104 from the PSF Tag 100. The PSF Tag 100 may also include rip indentations 122, FIG. 1A, that also facilitate the easy removal of any detachable tags. The search/rescue team may then leave the area with the top section of the tag still intact (the Final-Search-Completed tag 102), as shown in the sketch of the PSF tag 150 of FIG. 1C with the Final-Search tag removed, leaving only the Final-Search-Completed tag 102. PSF Tag 150 may remain on doorknobs/handrails or adhered to the door/wall area, as the case may be, until the PSF tags are disposed of by building personnel when the fire incident is completed and struck out.

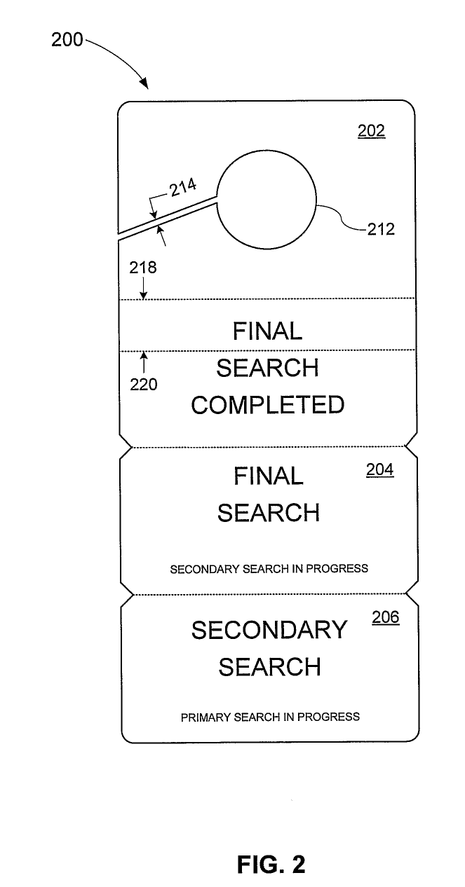

FIG. 2 shows a sketch of another example of a PSF tag 200 in accordance with the present invention. PSF tag 200 is similar to PSF tag 100, FIG. 1C, having a Secondary-Search tag 206, a Final-Search tag 204, and a Final-Search-Completed tag 202. In addition, PSF tag 200 also includes a gap 214 cut into Final-Search-Completed tag 202 connected to preformed hole 212. This facilitates attaching PSF tag 200 to doorknobs or other protrusions where possible without use of an adhesive, which may be applied on the reverse side of the PSF tag 200, in the area delineated by dashed lines 218 and 220.

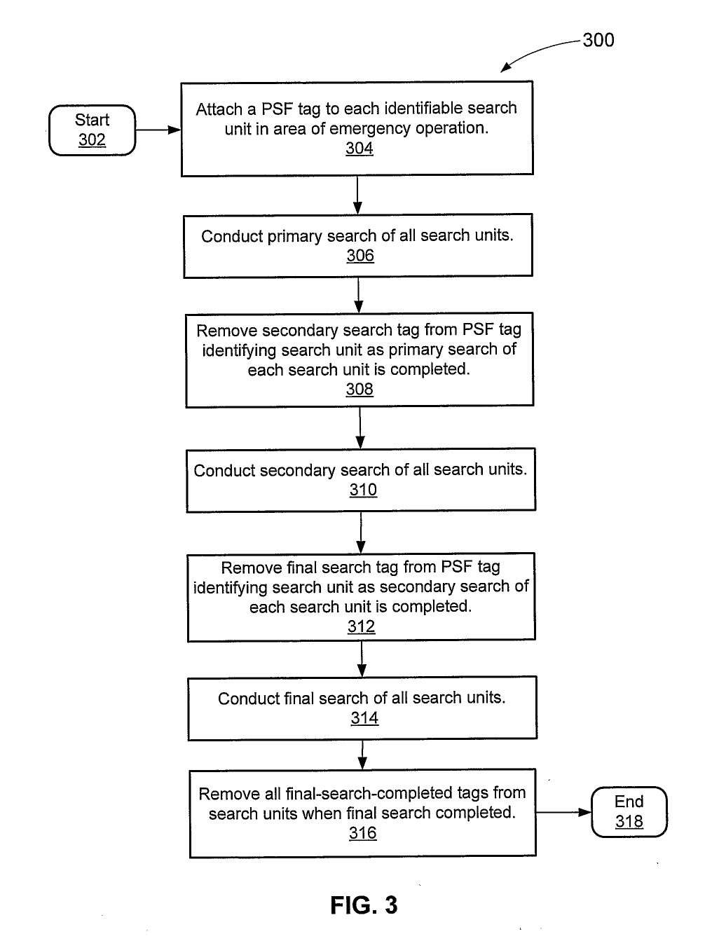

FIG. 3 shows a flow diagram of the steps performed in a process 300 using the PSF tags shown in FIGS. 1A and 2. The process of conducting an emergency search operation begins in step 302, and in step 304, a PSF tag is attached to each identifiable search unit within the search area where a fire, rescue, or other emergency operation is to be conducted. In step 306, the fire or rescue team may begin conducting primary searches of all search units. In step 308, members of the fire or rescue team may remove the secondary-search tag from a PSF tag after they have completed a primary search of that search unit. These members may then proceed to conduct primary searches of other search units. In step 310, the fire or rescue team may begin conducting secondary searches of all search units. In process 300, these steps may overlap as, for example, step 310 may be in progress, i.e., secondary searches have begun, while there may still be primary searches being conducted in step 306 for other search units.

In step 312, members of the fire or rescue team remove the final-search tag from a PSF tag after they have completed a secondary search of that search unit. Again, these members may then proceed to conduct secondary searches of other search units. In step 314, the final search of all search units may begin. In step 316, the final-search-completed tags are removed when the final search has been completed for all search units, and the process ends in step 318.

Additional searches of marked areas may be instituted if conditions indicate that there is a need, such as receiving a report of missing civilians or missing team members. In cases such as these, there may be a different set of PSF tags used (i.e., different lettering), where the object of the search may be different from that of the original search, e.g., searching for a missing person after the fire has been extinguished. Also, there may be additional specialized PSF tags to indicate other unusual or dangerous conditions, e.g., to indicate the presence of hazardous materials.

The PSF tags may be used in any number of fire, rescue and/or emergency operations that require searching multiple enclosed areas. For example, in high rise buildings, a PSF Tag 100 may be placed on an office door or near an entrance to an enclosed area. This indicates that the office or the enclosed area is being searched or has been searched. In the case of single family dwellings, PSF tags may be placed on doors or walls of each room to indicate that a thorough search has been completed. In the case of multiple dwelling units and hotels, when placed on an apartment door, a PSF tag 100 indicates that the entire apartment is being searched or has been searched. When placed on an individual room door, a PSF tag 100 indicates that only this room is being searched or has been searched.

It is appreciated by those skilled in the art that there is a need for multiple sets of PSF tags for use at the scene of a fire or rescue operation. As an example of a possible distribution and replacement policy for the PSF tags, the PSF tags may be issued to all Engine, Truck, Tower Ladder and Squad companies in a fire district as follows:
A. Engine: 50 tags, 1 carrying case;
B. Trucks and Tower Ladders: 100 tags, 1 carrying case;
C. Squads: 75 tags, 1 carrying case;
D. H.I.T. Team: 50 tags, 1 carrying case;
E. Battalion Chiefs: 25 tags, 1 carrying case;
F. Deputy District Chiefs: 25 tags, 1 carrying case; and
G. Lost, stolen or used and exhausted tags may be replaced by ordering them from district headquarters.

Each set of PSF tags may be stored in a small carrying case, e.g., something in the size of a standard pencil case. The PSF tags may be made of any material that is light, flexible, and durable. As an example, the material used may be Carolina® coated paper. In another implementation, the material may be fire-resistant. The PSF tags may have a coat of lamination to increase durability. As described above, the size of each PSF Tag may vary as well as the color of the lettering and background (for example, either the lettering, the background, or both may be in any highly-visible coloring), the content of the lettering, the number of detachable tags, and the method of making any primary and secondary tags detachable or easily removable.

While the foregoing description refers to a firefighting primary, secondary, and final search tagging system for indicating the status of fire, rescue and emergency operations in a search area with multiple rooms or enclosed areas, the subject matter of this disclosure is not limited to such a tagging system but also includes, in general, any tagging system that may be used to conduct a standardized search where the search may include a single search or may include a plurality of stages, which, as an example, may be denominated preliminary, secondary, and final, and which are performed over a plurality of searchable units, such as rooms or other enclosed areas. The lettering that appears on the tags making up the tagging system may be varied depending on the purpose of the search; as an example, the search may be for hazardous materials and the lettering on the tags may be modified to reflect the purpose or the type of the search.

Moreover, it will be understood that the foregoing description of an implementation has been presented for purposes of illustration and description. It is not exhaustive and does not limit the claimed invention to the precise form disclosed. Modifications and variations are possible in light of the above description or may be acquired from practicing the invention. The claims and their equivalents will define the scope of the invention.

What is claimed:

1. A firefighting primary, secondary, and final search (“PSF”) tag (“PSFT”), the PSFT comprising:
a final-search-completed tag having a front and a reverse side;
an at least one search-in-progress tag detachably connected to the final-search-completed tag; and
means for attaching the PSFT to an object that identifies an enclosed area under search.

2. The PSFT of claim 1, wherein the at least one search-in-progress tag includes:
a final-search tag having a front and a reverse side detachably connected to the final-search-completed tag; and
a secondary-search tag having a front and a reverse side detachably connected to the final-search tag.

3. The PSFT of claim 2, wherein each of the final-search-completed tag, the final-search tag, and the secondary-search tag contains lettering on the front side referring to a final search completed, a final search, and a secondary search, respectively.

4. The PSFT of claim 3, wherein the means for attaching the PSFT to the surface includes a preformed hole in the final-search-completed tag.

5. The PSFT of claim 4, wherein the means for attaching the PSFT to the surface further includes a gap in the final-search-completed tag running from an edge of the final-search-completed tag to the preformed hole.

6. The PSFT of claim 4, wherein the means for attaching the PSFT to the surface includes an adhesive applied to the reverse side of the final-search-completed tag.

7. The PSFT of claim 6, further including:
a first perforation in the PSFT delineating the secondary-search tag from the final-search tag; and
a second perforation in the PSFT delineating the final-search tag from the final-search-completed tag.

8. The PSFT of claim 7, farther including rip indentations aligned with each of the first perforation and the second perforation.

9. The PSFT of claim 4, wherein a background of the front side of each of the final-search-completed tag, the final-search tag, and the secondary-search tag is in a color selected from a group consisting of day glow orange, day glow yellow, day glow green, and day glow red.

10. The PSFT of claim 9, wherein the lettering on the front side of each of the final-search-completed tag, the final-search tag, and the secondary-search tag is black.

11. A method for identifying the status of fire, rescue, and emergency operations in multi-unit structures, the method comprising:
attaching a firefighting primary, secondary, and final search (“PSF”) tag (“PSFT”) having a final-search-completed tag and at least one search-in-progress tag to each identifiable search unit within an area in which the fire, rescue, or emergency operation takes place;
removing the at least one search-in-progress tag from the PSFT when a primary search of an identifiable unit identified by the PSFT has been completed; and
removing the plurality of PSFTs upon completion of the fire, rescue, or emergency operation.

12. The method of claim 11, wherein the PSFT includes:
a final-search tag having a front and a reverse side detachably connected to the final-search-completed tag; and
a secondary-search tag having a front and a reverse side detachably connected to the final-search tag.

13. The method of claim 12, wherein removing the at least one search-in-progress tag includes:
removing the secondary-search tag from the PSFT when a primary search of an identifiable unit identified by the PSFT has been completed; and
removing the final-search tag from the PSFT when the secondary search of the identifiable unit has been completed.

14. The method of claim 13, wherein the identifiable search unit is a room or an enclosed area.

15. The method of claim 14, wherein attaching a PSFT to the identifiable search unit includes attaching a PSFT to a wall of the identifiable unit using an adhesive affixed to a reverse side of the PSFT.

16. The method of claim 14, wherein attaching a PSFT to the identifiable search unit includes placing the PSFT on a doorknob of a door to the identifiable unit using a preformed hole in the PSFT.

17. A tagging system for indicating the status of a search operation conducted in a search area having a plurality of searchable units, the tagging system comprising:
a search-status (“SS”) tag (“SST”) that includes:
a search-completed tag having a front and a reverse side; and
at least one search-in-progress tag having a front and a reverse side detachably connected to the search-completed tag; and
means for attaching the SST to an object that identifies a searchable unit.

18. The tagging system of claim 17, wherein the search-in-progress tag includes:
a final-search tag detachably connected to the search-completed tag; and
a secondary-search tag detachably connected to the final-search tag.

19. The tagging system of claim 18, wherein the means for attaching the SST to the object includes a preformed hole in the search-completed tag.

20. The tagging system of claim 19, wherein the means for attaching the SST to the object includes an adhesive applied to the reverse side of the SST.

21. The tagging system of claim 20, wherein a background of the front side of each of the search-completed tag and the at least one search-in-progress tag is in a color selected from a group consisting of day glow orange, day glow yellow, day glow green, and day glow red.

22. The tagging system of claim 21, wherein the lettering on the front side of the search-completed tag and the search-in-progress tag is black.
